(19) United States
(12) Patent Application Publication
(10) Pub. No.: US 2010/0131373 A1
(43) Pub. Date: May 27, 2010

(54) DYNAMIC ADVERTISEMENT TAGS

(75) Inventor: Phil Kubasov, New York, NY (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/323,125

(22) Filed: Nov. 25, 2008

(51) Int. Cl. G06Q 30/00

(52) U.S. Cl. 705/14.73

(57) ABSTRACT

Methods and systems for serving advertisements are provided. Methods employed by the systems may include receiving, at an exchange system, a request from a web site publisher to generate an inventory identifier. The request may include one or more targeting attributes to be associated with the inventory identifier. In response, an inventory identifier may be communicated to the web site publisher. The web site publisher may then request an advertisement tag based on the inventory identifier from the exchange system. The exchange system may then communicate an advertisement tag that includes the inventory identifier to the web site publisher. The advertisement tag may include browser code operable to cause a browser to request an advertisement associated with the one or more targeting attributes associated with the inventory identifier from an ad server.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

In some cases, advertisers may wish to show their respective advertisements on a particular web site. Other advertisers may be less interested in specific web sites and more interested in displaying advertisements across several web sites that cater to a specified target audience. For example, an automobile advertiser may want an automobile advertisement displayed on web sites that relate to automobiles and racing.

To facilitate advertisement placement, web site operators may provide exchange systems that allow web site publishers to register their respective web sites with the exchange system. During registration, the web site publisher submits information that characterizes the web site. Once the information is submitted, the exchange system provides the publisher with an ID that is associated with the information provided. The publisher then includes this ID in an ad tag inserted in the browser code associated with a web page hosted by the web site. An ad tag corresponds to hyper-text-markup-language (HTML) code and/or scripts operable to cause a browser to retrieve an advertisement from an ad server and to display the advertisement in the browser.

One problem with existing systems, however, is that the ID given to the web site publisher represents a set of static web site characteristics provided during registration. This may lead to a mismatch between web pages operating on the web site and the advertisements served to the web pages. For example, a given web site may generate content that targets women one day and then men the next. If the web site was initially characterized as targeting women, then the advertisements served will likely target women, even when the content of the web page is geared more towards men. This may ultimately lead to a lower return on investment for the advertiser and the web site publisher.

### BRIEF DESCRIPTION OF THE DRAWINGS

FIG. 1 depicts an exchange system;

FIG. 2 is a flow diagram of operations performed by the exchange system;

FIG. 3 is an exemplary ad tag request that may be communicated to the exchange system;

FIG. 4 is an exemplary ad tag response communicated in response to an ad tag request;

FIG. 5 is an exemplary executable ad tag script; and

FIG. 6 illustrates a general computer system, which may represent any of the computing devices referenced herein.

### DETAILED DESCRIPTION

The embodiments below relate to an exchange system that dynamically generates ad tags that are utilized to insert advertisements in web pages. Generally, the exchange system provides an environment in which web site publishers specify information that characterizes their respective websites. For example, demographic information related to a web sites' audience may be specified. Pricing information corresponding to advertisements displayed on the web sites may also be specified. Other information that characterize the web site may also be provided.

The exchange system also enables advertisers to specify search criteria so as to enable matching advertisements to suitable web sites. For example, an advertiser may specify target audience information that describes the desired audience for the advertisement. The target audience information may include the gender and age of the desired audience that the advertiser wishes to target. Other information that specifies the target audience may also be provided.

In addition to publishers and advertisers, ad networks may also interact with the web site advertising exchange system. Ad networks generally represent a number of publishers, advertisers or both. Ad networks enable small publishers and/or advertisers, who would otherwise find the cost associated with internet advertising to be prohibitive, to participate in online advertising. For example, an advertiser who is unable to purchase a minimum number of advertisement impressions specified by a web site publisher may join an ad network of similarly situated advertisers who collectively can purchase the minimum number of advertisement impressions specified. As used here, the term impression corresponds to the display of an advertisement to a user. The more relevant the impression is to the user, the higher the quality of impression.

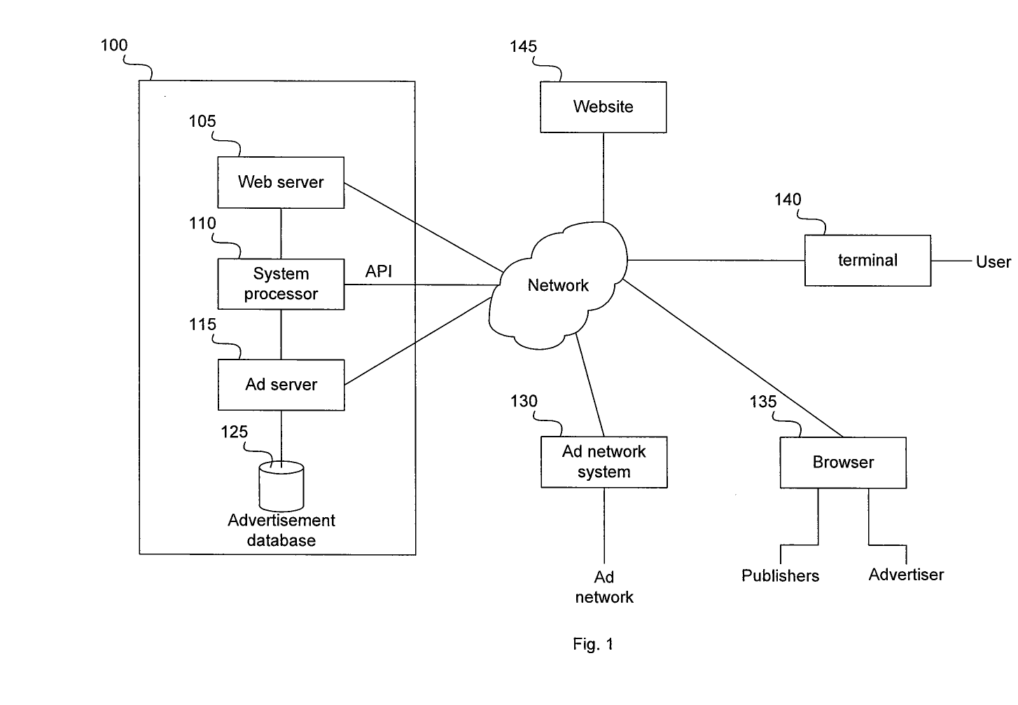

FIG. 1 depicts an exchange system 100. The exchange system 100 includes a web server 105, a system processor 110, an ad server 115, and an advertisement database 125. The web server 105, system processor 110, and ad server 115 may correspond to any generalized computing device, such as an Intel®, AMD®, and/or PowerPC® based computer running an operating system, such as a Microsoft Windows®, Linux®, and/or Unix® operating system. The web server 105, system processor 110, and ad server 115 may be adapted to communicate with other computers via an interface, such as a network interface. The functionally associated with the web server 105, system processor 110, and ad server 115 may reside on a single computing device or be distributed among multiple computing devices.

The web server 105 may also be adapted to communicate web pages via the network interface to a browser 135. For example, the web server 105 may include a web server application, such as Apache HTTP Server or Microsoft's® Internet Information Server. The web pages communicated may include fields that enable publishers to interact with the exchange system 100. For example, fields may be provided that enable a website publisher to specify information related to a website, such as the URL of the web site, demographic information related to the website's audience, advertisement placement information, and/or advertisement size information.

Other web pages communicated may include fields that enable advertisers to interact with the exchange system 100. These fields may enable an advertiser to locate web sites suitable for hosting a given advertisement. For example, fields may be provided that enable specifying demographic information related to a desired audience, a date range for running an advertisement, advertisement position information and/or advertisement size information. In addition, fields may be provided that enable specifying key words to be associated with the advertisement and also for specifying a money amount the advertiser is willing to pay to have the advertisement shown. Other fields may enable uploading an advertisement, sometimes referred to as a creative, to be displayed.

Information communicated via the web pages above may be processed by the system processor 110. For example, the system processor 110 may be operative to store web site information provided by publishers to a database, and to generate a unique identifier (ID) and associate the ID with the web site. The ID may then be incorporated into web pages generated by the publisher's web site, and utilized to identify the web pages when targeting advertisements to the web pages.

The system processor 110 may also be operative to store information provided by an advertiser, such as demographic, date range, advertisement position, and/or advertisement size information, to a database. Creatives communicated by the advertiser may be stored to an advertisement database 125. The system processor 110 may then locate publisher web sites that match criteria specified by an advertiser and also association information that enables associating advertisements from the advertiser with the located web sites. The association information may be communicated to the ad server 115.

The system processor 110 may also provide an application-program-interface (API), such as a web services interface defined by the World Wide Web Consortium (W3C), that enables communicating the information described above to and from systems outside of the exchange system 100. For example, the API may enable communications with an ad network system 130 operated by an ad network agency. Ad network agency may prefer to utilize custom applications rather than the interface provided via the web server 105 to manage numerous publisher websites and/or advertisers. To facilitate these communications, the API may include functions that enable specifying publisher web site information, such as a URL of the web site, demographic information related to the website's audience, advertisement placement information, advertisement size information, or any other information a publisher may provide via the web page interface. Functions may also be provided that enable specifying advertiser information, such as demographic information related to a desired audience, a date range for running an advertisement, advertisement position information, advertisement size information, or any other information an advertiser may provide via the web page interface. Functions that enable specifying key words to be associated with the advertisement, and also for specifying a money amount the advertiser is willing to pay to have the advertisement shown may be provided. Other functions may be provided for uploading an advertisement, or creative, to be displayed on a web site. The functions identified above and the results returned from the functions may be communicated via a SOAP protocol defined by the World Wide Web Consortium (W3C).

Functions may also be provided that enable specifying advertiser information, such as demographic information related to a desired audience, a date range for running an advertisement, advertisement position information, advertisement size information, or any other information an advertiser may provide via the web page interface. Functions that enable specifying key words to be associated with the advertisement, and also for specifying a money amount the advertiser is willing to pay to have the advertisement shown may be provided. Other functions may be provided for uploading an advertisement, or creative, to be displayed on a web site. The functions identified above and the results returned from the functions may be communicated via a SOAP protocol defined by the World Wide Web Consortium (W3C).

The ad server 115 may be adapted to communicate advertisements stored in the advertisement database 125 to a browser operating on a user terminal 140 in response to a request for serving an advertisement. For example, web page information on a web site 145 may be communicated to a user terminal 140. The web page information may include a place holder for an advertisement. The place holder may correspond to an advertisement tag, or ad tag. The ad tag may include information that identifies the web page, such as a unique ID as described above. When processing the web page information, the browser operating on the user terminal 140 may communicate the ad tag to the ad server 115. In response, the ad server 115 may locate an advertisement previously associated with the unique ID and communicate the advertisement to the browser.

In the one embodiment, the communicated ad tag may include a dynamically created inventory identifier. The inventory identifier may be associated with a set of targeting attributes specified by a web site publisher. For example, a publisher of a web site that delivers news articles may analyze each article to determine whether the article is more suited to a particular audience, such as an article related to NASCAR® racing. The publisher may then communicate targeting attributes that characterize the web site to the system processor 110. The system processor 110 may return an ad tag that includes an inventory identifier that is associated with the communicated targeting attributes. The publisher may then include the ad tag into the browser code associated with the news article and communicate the browser code to the user terminal 140. After receiving the browser code, the ad tag may cause the terminal to communicate the inventory identifier to the ad server 115. The ad server 115 may then locate advertisements related to the targeting parameters associated with the inventory identifier. After locating related advertisements, the ad server 115 may communicate one or more of the related advertisements to the user terminal 140.

In an another embodiment, the targeting attributes may be included as parameters in the ad tag itself. The ad tag with the targeting attributes may be communicated as described above and the ad server 115 may locate and communicate one or more advertisements related to the targeting attributes to the user terminal 140.

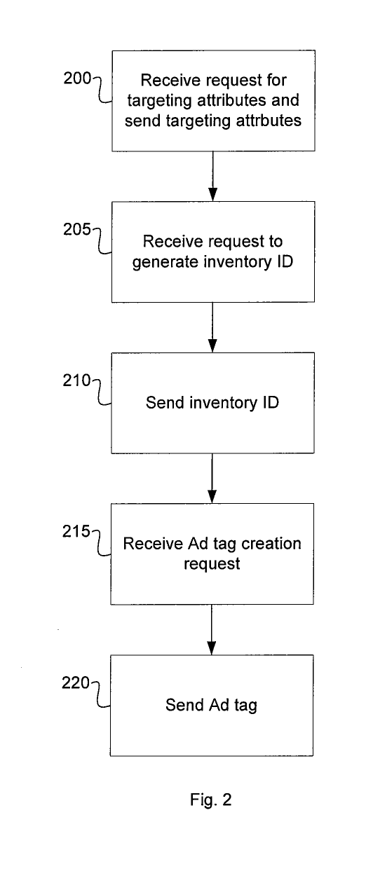

FIG. 2 is a flow diagram of operations performed by the exchange system 100 of FIG. 1. At block 200, a request to provide targeting attributes supported by the exchange system 100 may be received by the exchange system 100. For example, a web site publisher may request targeting attributes supported by the exchange system 100 by communicating a SOAP message that request the information to the exchange system 100. In response, the exchange system 100 may communicate a list of targeting attributes supported by the exchange system 100.

At block 205, a request to generate an inventory identifier may be communicated from the web site publisher to the exchange system 100. The request may include a web site ID parameter that represents the publisher's web site. The request may also include one or more targeting attributes. The targeting attributes may correspond to attributes that characterize the web site and may correspond to one or more of the targeting attributes supported by the exchange system 100.

In some cases, the request may also include one or more custom attributes. For example, the attributes may specify an advertisement size that is appropriate for the advertisement space available on web pages communicated from the web site. The advertisement delivery mode may also be specified. The advertisement delivery mode corresponds to the position of the advertisement on web pages communicated from the web site.

In addition to the attributes above, attributes that define a custom content may be communicated. These attributes may be communicated when the supported targeting attributes are not suitable for characterizing the publisher's web site. For example, the web site may relate to a topic never before seen on the Internet. In this case, the targeting attributes registered with the exchange system may not enable sufficiently characterizing the web site. When custom content attributes are specified, the custom content attributes may be added to the list of supported targeting attributes and made available to advertisers, so that advertisers may target advertisements based on the custom content attributes.

At block 210, the exchange system 100 may communicate an inventory identifier to the web site publisher. The exchange system 100 may associate the inventory identifier with the targeting attributes and/or any other attributes specified at block 205.

At block 215, a request for generating an ad tag may be received. An ad tag corresponds to hyper-text-markup-language (HTML) code and/or scripts operable to cause a browser to retrieve an advertisement from an ad server and to display the advertisement in the browser. The request may be communicated from the publisher to the exchange system 100 and may include the inventory identifier communicated at block 210. The request may be communicated via a SOAP protocol.

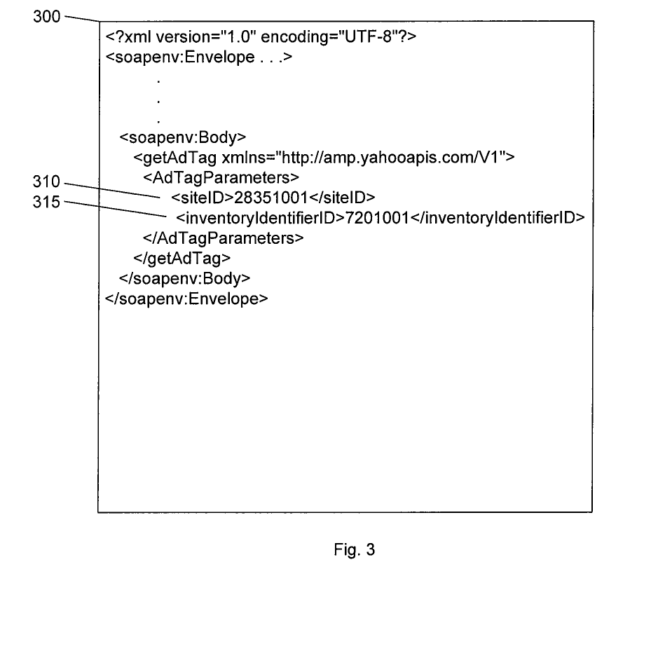

FIG. 3 is an exemplary ad tag request 300 that may be communicated to the exchange system 100. The ad tag request 300 includes a web site ID parameter 310 and an inventory ID parameter 315. In this example, the web site ID parameter 310 corresponds to “28351001” and the inventory ID parameter 315 corresponds to “7201001.”

Returning to FIG. 2, at block 220, the exchange system 100 may communicate an ad tag to the web site publisher in response to the request at block 300. As above, the ad tag may be communicated via a SOAP protocol and may include the inventory ID specified in the request.

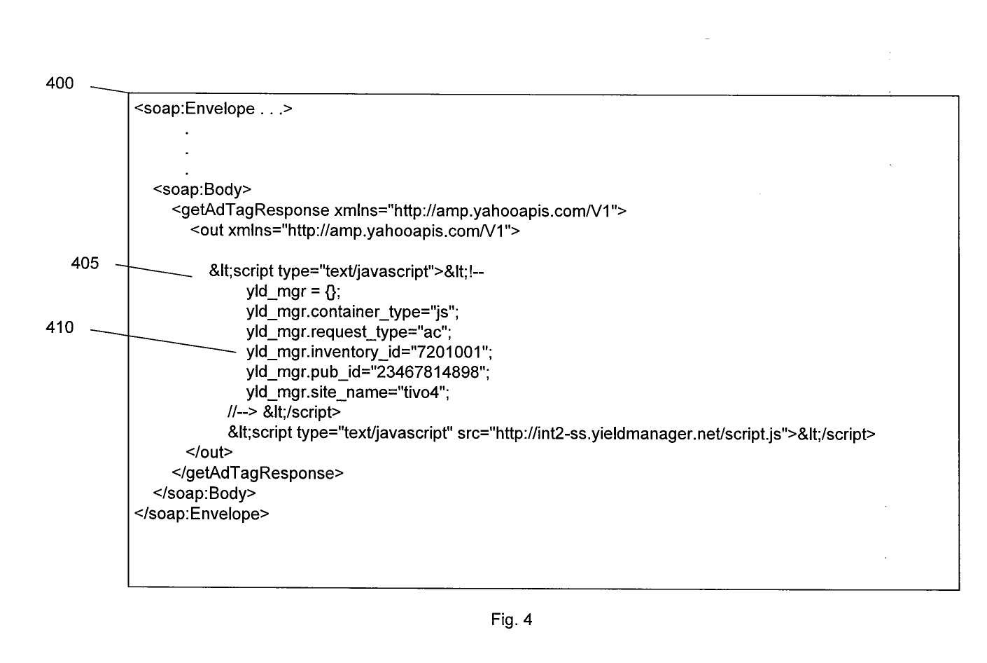

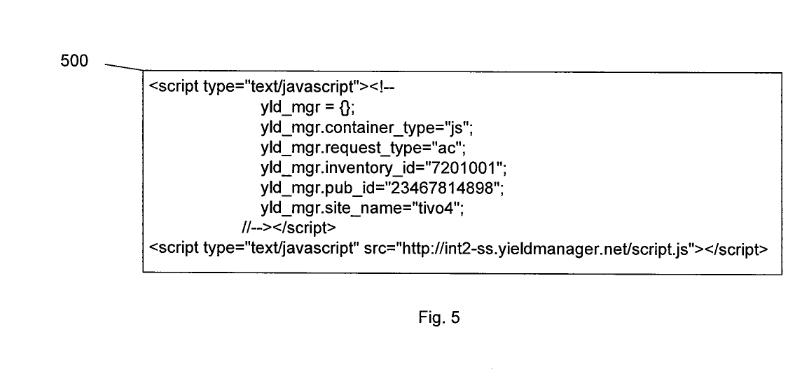

FIG. 4 is an exemplary ad tag response 400 communicated in response to an ad tag request. The ad tag response 400 includes an ad tag script 405. The ad tag script 405 includes an inventory identifier 410 that corresponds to the inventory identifier communicated at block 215. In the one embodiment, all occurrences of the character sequence “&It;” in the ad tag script 405 are replaced by the character “<”, which results in the exemplary executable ad tag script 500 shown in FIG. 5.

Once the ad tag script is formatted, the ad tag script is ready to be inserted into browser code and communicated to a user terminal. For example, a web site publisher may insert the ad tag script into browser code that defines a news article. The browser code may then be communicated to a user terminal. The user terminal may then execute the ad tag script. The code in the ad tag script may be operable to cause the terminal to communicate an advertisement request to an ad server, such as the ad server 115 of FIG. 1. The advertisement request may include the inventory identifier. The ad server may then locate advertisements related to the targeting attributes associated with the inventory identifier and then communicate one or more of the related advertisements to the user terminal.

One advantage of this approach is that it allows a web site publisher to dynamically characterize web pages on the web site. This in turn enables more relevant placement of advertisements. For example, the publisher of a news related web site may characterize each article displayed via the web site every day. After characterizing the articles, the publisher may request an inventor ID that is associated with the characteristic attributes that define the articles, via the operations above. The publisher may then request an ad tag operative to cause advertisement related to the article to be displayed on a browser. This leads to an improved return on investment for the advertiser and the web site publisher.

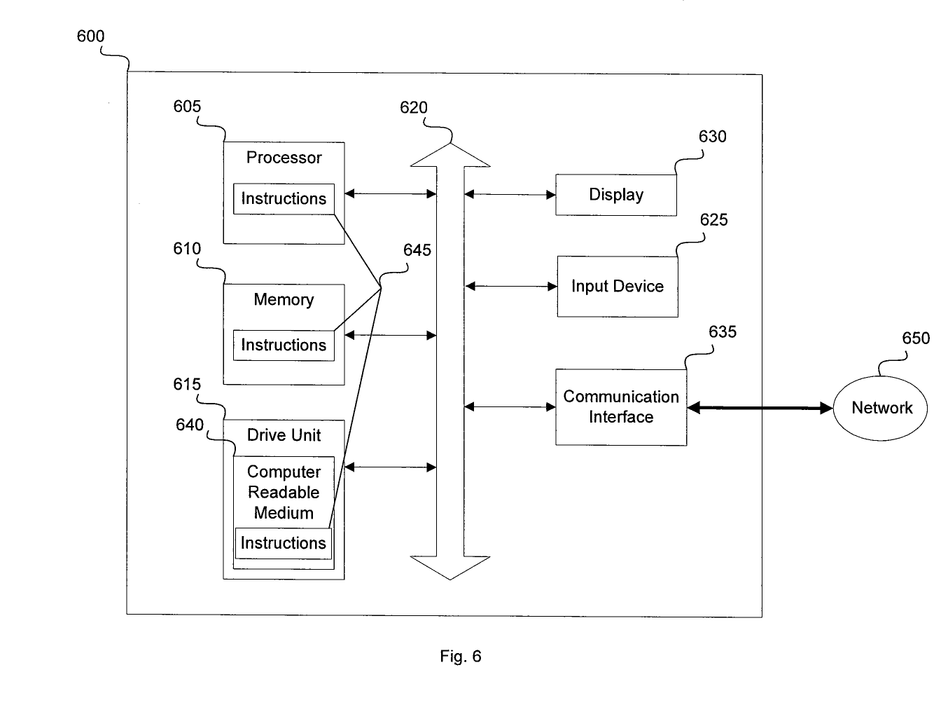

FIG. 6 illustrates a general computer system 600, which may represent web server 105, system processor 110, and ad server 115 of FIG. 1, or any of the other computing devices referenced herein. The computer system 600 may include a set of instructions 645 that may be executed to cause the computer system 600 to perform any one or more of the methods or computer-based functions disclosed herein. The computer system 600 may operate as a stand-alone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 645 (sequential or otherwise) that specify actions to be taken by that machine. In one embodiment, the computer system 600 may be implemented using electronic devices that provide voice, video or data communication. Further, while a single computer system 600 may be illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 605, such as a central processing unit (CPU), a graphics processing unit (GPU), or both. The processor 605 may be a component in a variety of systems. For example, the processor 605 may be part of a standard personal computer or a workstation. The processor 605 may be one or more general processors, digital signal processors, application specific integrated circuits, field programmable gate arrays, servers, networks, digital circuits, analog circuits, combinations thereof, or other now known or later-developed devices for analyzing and processing data. The processor 605 may implement a software program, such as code generated manually (i.e., programmed).

The computer system 600 may include a memory 610 that can communicate via a bus 620. For example, the advertisement database 120 may be stored in the memory. The memory 610 may be a main memory, a static memory, or a dynamic memory. The memory 610 may include, but may not be limited to, computer readable storage media such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one case, the memory 610 may include a cache or random access memory for the processor 605. Alternatively or in addition, the memory 610 may be separate from the processor 605, such as a cache memory of a processor, the system memory, or other memory. The memory 610 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 610 may be operable to store instructions 645 executable by the processor 605. The functions, acts or tasks illustrated in the figures or described herein may be performed by the programmed processor 605 executing the instructions 645 stored in the memory 610. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 600 may further include a display 630, such as a liquid crystal display (LCD), an organic light emitting diode (OLED), a flat panel display, a solid state display, a cathode ray tube (CRT), a projector, a printer or other now known or later-developed display device for outputting determined information. The display 630 may act as an interface for the user to see the functioning of the processor 605, or specifically as an interface with the software stored in the memory 610 or in the drive unit 615.

Additionally, the computer system 600 may include an input device 625 configured to allow a user to interact with any of the components of system 600. The input device 625 may be a number pad, a keyboard, or a cursor control device, such as a mouse, or a joystick, touch screen display, remote control or any other device operative to interact with the system 600.

The computer system 600 may also include a disk or optical drive unit 615. The disk drive unit 615 may include a computer-readable medium 640 in which one or more sets of instructions 645, e.g. software, can be embedded. Further, the instructions 645 may perform one or more of the methods or logic as described herein. The instructions 645 may reside completely, or at least partially, within the memory 610 and/or within the processor 605 during execution by the computer system 600. The memory 610 and the processor 605 also may include computer-readable media as discussed above.

The present disclosure contemplates a computer-readable medium 640 that includes instructions 645 or receives and executes instructions 645 responsive to a propagated signal, so that a device connected to a network 650 may communicate voice, video, audio, images or any other data over the network 650. The instructions 645 may be implemented with hardware, software and/or firmware, or any combination thereof. Further, the instructions 645 may be transmitted or received over the network 650 via a communication interface 635. The communication interface 635 may be a part of the processor 605 or may be a separate component. The communication interface 635 may be created in software or may be a physical connection in hardware. The communication interface 635 may be configured to connect with a network 650, external media, the display 630, or any other components in system 600, or combinations thereof. The connection with the network 650 may be a physical connection, such as a wired Ethernet connection or may be established wirelessly as discussed below. Likewise, the additional connections with other components of the system 600 may be physical connections or may be established wirelessly.

The network 650 may include wired networks, wireless networks, or combinations thereof. The wireless network may be a cellular telephone network, an 802.11, 802.16, 802.20, or WiMax network. Further, the network 650 may be a public network, such as the Internet, a private network, such as an intranet, or combinations thereof, and may utilize a variety of networking protocols now available or later developed including, but not limited to, TCP/IP based networking protocols.

The computer-readable medium 640 may be a single medium, or the computer-readable medium 640 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 640 may include a solid-state memory such as a memory card or other package that houses one or more non-volatile read-only memories. The computer-readable medium 640 also may be a random access memory or other volatile re-writable memory. Additionally, the computer-readable medium 640 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As can be seen from above, the embodiments described provide an exchange system that allows publishers to dynamically characterize their respective web sites. For example, the publisher may request currently supported targeting attributes from the exchange system. The publisher may then request an inventory identifier to be associated with targeting attributes that characterize his web site. The targeting attributes may include supported targeting attributes and/or custom attributes. Once the inventory identifier is generated, the publisher may request an ad tag operative to cause advertisements related to the targeting attributes to be served to the publisher's web site. The ad tag may include the inventory identifier. An advantage of this approach is that it allows the publisher to dynamically re-characterize his web site, or web pages served from his web site, so as to enable delivering more relevant advertisements to users. This results in a greater return on investment to advertisers because the advertisements are more relevant to the users and also greater return on investment to the publisher because he is able to deliver higher quality impressions.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

I claim:

1. A method for serving advertisements, the method comprising:
receiving, at an exchange system, a request to generate an inventory identifier, the request including one or more targeting attributes to be associated with the inventory identifier;
communicating the inventory identifier to a requestor associated with the request to generate the inventory identifier;
receiving a request to generate an advertisement tag, the request including the inventory identifier; and
communicating the advertisement tag to a requestor associated with the request to generate the advertisement tag, where the advertisement tag includes the inventory identifier and is operable to cause a browser to request an advertisement associated with the one or more targeting attributes associated with the inventory identifier from an ad server.

2. The method according to claim 1, further comprising receiving a request to provide targeting attributes supported by the exchange system.

3. The method according to claim 1, wherein the one or more targeting attributes includes one or more custom content attributes.

4. The method according to claim 3, further comprising adding the custom content attributes to targeting attributes supported by the exchange system.

5. The method according to claim 4, wherein the custom content attributes include at least one of: advertisement size information, advertisement delivery mode information, web page content information, and custom information.

6. The method according to claim 5, wherein the advertisement delivery mode information defines a location on a web page for displaying an advertisement.

7. The method according to claim 5, wherein the advertisement size information defines a size of the location on the web page for displaying an advertisement.

8. A method for serving advertisements, the method comprising:
associating an inventory identifier with one or more targeting attributes;
receiving a request to serve an advertisement, the request including the inventory identifier; and
communicating an advertisement associated with the one or more targeting attributes associated with the inventory identifier to a browser.

9. A machine-readable storage medium having stored thereon, a computer program comprising at least one code section for serving advertisements, the at least one code section being executable by a machine for causing the machine to perform acts of:
receiving, at an exchange system, a request to generate an inventory identifier, the request including one or more targeting attributes to be associated with the inventory identifier;
communicating the inventory identifier to a requestor associated with the request to generate the inventory identifier;
receiving a request to generate an advertisement tag, the request including the inventory identifier; and
communicating the advertisement tag to a requestor associated with the request to generate the advertisement tag, where the advertisement tag includes the inventory identifier and is operable to cause a browser to request an advertisement associated with the one or more targeting attributes associated with the inventory identifier from an ad server.

10. The machine-readable storage according to claim 9, wherein the at least one code section comprises code that enables receiving a request to provide targeting attributes supported by the exchange system.

11. The machine-readable storage according to claim 9, wherein the one or more targeting attributes includes one or more custom content attributes.

12. The machine-readable storage according to claim 11, wherein the at least one code section comprises code that enables adding the custom content attributes to targeting attributes supported by the exchange system.

13. The machine-readable storage according to claim 12, wherein the custom content attributes include at least one of: advertisement size information, advertisement delivery mode information, web page content information, and custom information.

14. The machine-readable storage according to claim 13, wherein the advertisement delivery mode information defines a location on a web page for displaying an advertisement.

15. The machine-readable storage according to claim 14, wherein the advertisement size information defines a size of the location on the web page for displaying an advertisement.

16. A system for serving advertisements, the system comprising:
logic stored in a memory and executable by an exchange system to receive a request to generate an inventory identifier, the request including one or more targeting attributes to be associated with the inventory identifier; and
the logic stored in the memory is also executable by the exchange system to communicate the inventory identifier to a requestor associated with the request to generate the inventory identifier; receive a request to generate an advertisement tag, the request including the inventory identifier; and to communicate the advertisement tag to a requester associated with the request to generate the advertisement tag, where the advertisement tag includes the inventory identifier and is operable to cause a browser to request an advertisement associated with the one or more targeting attributes associated with the inventory identifier from an ad server.

17. The system according to claim 16, wherein the logic stored in the memory is also executable by the exchange system to receive a request to provide targeting attributes supported by the exchange system.

18. The system according to claim 16, wherein the one or more targeting attributes includes one or more custom content attributes.

19. The system according to claim 18, wherein the logic stored in the memory is also executable by the exchange system to add the custom content attributes to targeting attributes supported by the exchange system.

20. The system according to claim 19, wherein the custom content attributes include at least one of: advertisement size information, advertisement delivery mode information, web page content information, and custom information.

21. The system according to claim 20, wherein the advertisement delivery mode information defines a location on a web page for displaying a advertisement.

22. The system according to claim 20, wherein the advertisement size information defines a size of the location on the web page for displaying an advertisement.
